(19) United States
(12) Patent Application Publication
(10) Pub. No.: US 2005/0267261 A1
(43) Pub. Date: Dec. 1, 2005

(54) Low gloss thermoplastic polyolefin composition

(75) Inventor: F. Michael Plaver, Midland, MI (US)

Correspondence Address: DOBRUSIN & THENNISCH PC, 29 W LAWRENCE ST, SUITE 210, PONTIAC, MI, 48342, US

(73) Assignee: Dow Global Technologies, Inc.

(21) Appl. No.: 11/128,944

(22) Filed: May 13, 2005

Related U.S. Application Data
(60) Provisional application No. 60/571,143, filed on May 14, 2004.

(51) Int. Cl. C08F 8/00; C08L 23/00

(52) U.S. Cl. 525/191; 525/240

(57) ABSTRACT

The present invention relates to an impact resistant composition having a polyolefin, an elastomer with a Mooney viscosity of greater than about 40 and an elastomer with a Mooney viscosity of less than about 40. The present invention also relates to an impact resistant composition having a polyolefin and a coupled elastomer with a Mooney viscosity of greater than about 40. Further, the present invention relates to compositions having a polypropylene blend with a heat of crystallization of greater than about 150° C., a coupled ethylene-α-olefin with a Mooney viscosity of greater than about 40 and an ethylene-α-olefin with a Mooney viscosity of between about 30 and about 40.

### CLAIM OF PRIORITY

The present application claims the benefit of provisional application 60/571,143, filed on May 14, 2004, which is hereby incorporated by reference.

### FIELD OF THE INVENTION

The present invention relates to thermoplastic compositions that show an improved balance between gloss and impact resistance.

### BACKGROUND OF THE INVENTION

Low gloss thermoplastic materials have been desirable recently for use in automobiles and other applications. In the past, matte appearance has been a trade off with impact resistance and modulus (stiffness). As gloss goes down (more desirable), so does impact resistance and modulus (less desirable). To achieve low gloss, additional filler materials have been used. In many applications, however, these types of fillers tend to impair the mechanical properties of the resultant article while also not consistently providing a uniform finish. Another technique has been to combine a rubber-reinforced thermoplastic and an ethylene-α-olefin copolymer with a Mooney viscosity of 40 to 110. As above, these materials do not provide a sufficiently high impact resistance or modulus in a cost effective manner.

Low gloss may also be achieved through the use of an appropriate surface texture on the injection molding tool. However, maintaining very low gloss over time in production may require frequent surface cleaning/re-texturing, which can be expensive and labor intensive.

Consequently, the inventor has discovered compositions and methods that overcome one or more these disadvantages.

### SUMMARY OF THE INVENTION

The present invention relates to an impact resistant composition having a polyolefin, a first elastomer with a Mooney viscosity of greater than about 40 and a second elastomer with a Mooney viscosity of less than about 40. The present invention also relates to at least one impact resistant composition having a polyolefin and a coupled elastomer with a Mooney viscosity of greater than about 40. Further, the present invention relates to compositions having a polypropylene blend with a heat of crystallization of greater than about 150° C., a coupled ethylene-α-olefin elastomer with a Mooney viscosity of greater than about 40 and an ethylene-α-olefin elastomer with a Mooney viscosity of between about 30 and about 40.

### DETAILED DESCRIPTION

The present invention relates to thermoplastic compositions that exhibit a cost-effective balance between impact resistance and modulus, on the one hand, and low gloss, on the other hand. In one specific example, the composition of the present invention may include as few as three components, namely a polyolefin; a first elastomer and a second elastomer. Other ingredients that do not material effect the beneficial properties may also be employed. In another specific example, the compositions comprise the combination of a polyolefin and at least one coupled elastomer, with a Mooney viscosity of greater than about 40.

The polyolefin may be any material that is derived from the polymerization of an olefin (i.e. alkene). Exemplary olefins include polypropylenes. In addition, homopolymers, random copolymers, heterophasic copolymers blends, and combinations thereof of polyolefins may be suitable. Heterophasic copolymers typically will include a semi-crystalline polyolefinic matrix with a nearly amorphous elastomeric component dispersed within the matrix. In addition, blends that include polyolefins may also be used such those including branched copolymers or block copolymers. Any catalyst system may be used to prepare the polyolefins of the present invention including Zeigler-Natta catalysts, constrained geometry catalysts, metallocene catalysts, any combination thereof, or any other suitable catalysts, with Zeigler-Natta catalysts being preferred. Specific examples of polyolefins includes those with a heat of crystallization of at least about 150° C., a melt flow index of between 1 and 100 g/10 minute tested according to ASTM D-1238 at 230° C./2.16 kg, or both. The polyolefin may have any density.

Polypropylenes are preferred, however, polyethylenes may be suitable as would more complex polyolefins, such as those that result from the polymerization of cyclic olefins. While blends or mixture of polyolefins are preferred, the use of single component polyolefins is also contemplated. Most preferred is a blend of two different kinds of polypropylene. While any polypropylene may be utilized, preferred polypropylenes include those that have a melt flow index between 10 and 70 g/10 min at 230° C./2.16 kg tested under ASTM D-1238. In a preferred embodiment, one polypropylene in the blend is a heterophasic copolymer of polypropylene and a homopolymer of polypropylene. Such a blend balances a higher modulus material with a lower modulus material that has improved impact resistance. The two components of a polypropylene blend may be in any ratio to each other with ratios between about 50:1 and about 1:50 of the heterophasic copolymer to the homopolymers.

The first and second elastomers may be selected from any of the variety of available natural and synthetic rubbers such thermoplastic vulcanizates, thermoplastic elastomers, thermoset elastomers, fluoroelastomers, butyl rubbers, EPDM, combinations thereof and the like. Preferably the first and second elastomer are selected from ethylene-α-olefin elastomers. Such ethylene-α-olefins include copolymers of ethylene and α-olefins, terpolymers of ethylene, α-olefins and nonconjugated dienes, and combinations thereof.

The carbon number of the said α-olefins is usually 3 to 20, preferably 3 to 12. Examples of the said α-olefins are propylene, 1-butene, 1-pentene, 1-hexene, 4-methyl-1-pentene, 1-heptene, 1-octene, 1-decene, 1-dodecene, 1-hexadecene and 1-eicosene. Of these α-olefins, octene is preferred, to thereby provide ethylene-α-octene as a preferred elastomer. Preferably, the elastomers are produced using metallocene catalysts. However, other types of catalyst systems (e.g. Zeigler-Natta catalysts, constrained geometry catalysts, or the like) may also be suitable.

The first and second elastomers may be distinguished by at least one physical property such as its viscosity (e.g. its Mooney viscosity). For example, the first elastomer preferably has a Mooney viscosity of at least about 40; preferably between about 40 and about 75 and more preferably between about 40 and about 60. The second elastomer preferably has a Mooney viscosity of less than about 40; preferably between about 20 and about 40 and more preferably between about 30 and about 40. Previously, metallocene catalyzed ethylene-α-olefin elastomer with a Mooney viscosity greater than about 40, and in particular metallocene catalyzed ethylene-α-octene elastomers with this range of Mooney viscosities, have not been known. Such metallocene catalyzed ethylene-α-olefins are desirable because they are economical compared to other elastomer catalyzed by other systems. The increase in Mooney viscosity typically represents an increase in the molecular weight of the elastomer. Suitable ratios of first to second elastomers include all first elastomer to no second elastomer on the one hand to no first elastomer to all second elastomer on the other hand.

Any type of elastomer that has a Mooney viscosity of greater than about 40 may be suitable for use as a first elastomer, without regard to the composition or catalyzed system utilized. For example, hydrocarbon rubbers may be used, such as those supplied by DuPont Dow Elastomers, under the designation Nordel®.

Preferably, metallocene catalyzed ethylene-α-olefins that have been coupled are used as the first elastomer. Coupled elastomers are ethylene-α-olefins that have been treated with a coupling agent. The coupling agent increases the molecular weight of the elastomer. This can be seen through an increase in the Mooney viscosity of the coupled elastomer compared with an elastomer that has not been treated with a coupling agent.

Corresponding to the increase in the Mooney viscosity in the coupled elastomer, there is a decrease in the melt flow index. Preferably, the coupled elastomer has a melt flow index of less than about 1 g/10 min and more preferably less than about 0.2 g/10 min at 190° C./2.16 kg (ASTM D-1238). In comparison, the second elastomer preferably has a melt flow index of less than about 1 g/10 min and more preferably less than about 0.5 g/10 min under the same conditions.

One method of producing coupled ethylene-α-olefin elastomers may be adapted from the method of producing coupled polypropylene described in co-owned U.S. Pat. No. 6,472,473, which is incorporated by reference. The process to produce this coupled elastomer involves coupling of the ethylene-α-olefin elastomer using a coupling agent. The coupling reaction is implemented via reactive extrusion or any other method which is capable of mixing the coupling agent with the ethylene-α-olefin elastomer and includes adding sufficient energy to cause a coupling reaction between the coupling agent and the ethylene-α-olefin elastomer. Preferably, the process is carried out in a single vessel such as a melt mixer or a polymer extruder, where extruder is intended to include its broadest meaning and includes such devices as a device which extrudes pellets as well as an extruder which produces the extrudate for forming into films, blow molded articles, profile and sheet extruded articles, foams and other articles.

Suitable coupling agents include chemical compounds that contain at least two reactive groups that are each capable of forming a carbene or nitrene group that are capable of inserting into the carbon hydrogen bonds of CH, CH₂, or CH₃ groups, both aliphatic and aromatic, of a polymer chain. The reactive groups together can couple polymer chains. It may be necessary to activate a coupling agent with heat, sonic energy, radiation or other chemical activating energy, for the coupling agent to be effective for coupling polymer chains. Examples of chemical compounds that contain a reactive group capable of forming a carbene group include, for example, diazo alkanes, geminally-substututed methylene groups, and metallocarbenes. Examples of chemical compounds that contain reactive groups capable of forming nitrene groups, include, but are not limited to, for example, phosphazene azides, sulfonyl azides, formyl azides, and azides. The preferred coupling agent is a poly(sulfonyl azide), more preferably a bis(sulfonyl azide).

While it is possible that the first elastomer could be used alone, particularly if a coupled elastomer is used, it is preferable to use the first and second elastomers in combination. Preferred starting materials for the coupled elastomer and preferred second elastomers include ENGAGE® polyolefins available from DuPont Dow Elastomers. Other suitable elastomers include those discussed in co-owned U.S. Pat. Nos. 5,576,374; 5,681,897, and their continuations, all of which are hereby incorporated by reference.

In addition to the polyolefin, the first elastomer, and the optional second elastomer, the present invention may include any of a number of fillers. Fillers which are useful include inorganic fillers such as talc, carbon black, graphite, carbon fibers, calcium carbonate, clay, feldspar, nepheline, silica, glass, filmed silica, alumina, magnesium oxide, zinc oxide, barium sulfate, aluminum silicate, calcium silicate, titanium dioxide, titanates, glass microspheres, starch, chalk, natural or synthetic fibers (e.g. aramid fibers, polyolefin fibers, pulp, cotton, etc.). Of these fillers, talc, calcium carbonate, silica/glass, alumina and titanium dioxide are preferred and talc is most preferred. Ignition resistance fillers which may be used in the improved low temperature impact resistant formulations include antimony oxide, decabromobiphenyl oxide, alumina trihydrate, magnesium hydroxide, borates, and halogenated compounds. Of these ignition resistant fillers, alumina trihydrate and magnesium hydroxide are preferred. Other additives might include antioxidants (e.g., hindered phenolics ( such as Irganox® 1010), phosphites (e.g., Irgafos® 168)), ultraviolet absorbers, cling additives (e.g., PIB), antiblock additives, thermal stabilizers, flame retardants, antibacterial agents, anti-mildew agents, plasticizers, antistatic agents, pigments, colorants, and the like can also be included in the present compositions.

The proportions of each component may be selected from a range of weight percentages. For example, the polyolefin may be present in amounts between about 50 wt % to about 90 wt %, and the first elastomer may be present in amounts between about 1 wt % and about 30 wt %, with the balance made up of fillers. Ratios of polyolefins to first elastomer may be in the range of between about 90:1 and about 5:3. In a preferred embodiment, the polypropylene blend may be present in amounts of between about 55 wt % and 65 wt % with the first elastomer present in amounts of between about 5 wt % and about 20 wt %. In a preferred embodiment, the ratio of polyolefins to first elastomer may be between about 13:1 and about 2.75:1. Similarly, the second elastomer may be present in amounts of between about 0 wt % and about 20 wt %. Ratios of polyolefins to second elastomer may be in the range of between about 100:1 and about 5:2. Illustrative compositions are also shown below in the Examples.

The thermoplastic resin composition of the present invention may be obtained by mixing the respective components with suitable means such as various types of extruder, mixer (e.g. Banbury mixer), kneader, roll mill, or the like. Mixing of the components can be effected either by adding them all at one time or by adding them in several portions. The components may be mixed by a multi-stage addition system with an extruder or may be mixed and then pelletized by an extruder.

The thermoplastic resin composition according to the present invention can be formed into a variety of articles by known methods such as injection molding, sheet forming, extrusion molding, vacuum molding, profile molding, foam molding, injection pressing, blow molding, thermoforming, compression molding, rotational molding, extrusion, or the like.

The present invention also relates to methods of resisting an impact on an object. Such methods may include forming an article from the materials previously discussed. The methods may also include preserving the integrity of the article upon the exposure of the article to a force. While it is preferred that the article substantially remains in tact during or after exposure to the force, this is not necessarily the case. That is, an article can shatter or other break up during exposure to the force as way of absorbing or dissipating impact energy. Stated another way, the methods may include resisting an impact by deflecting the impacting object or force, absorbing impact energy or otherwise dissipating impact energy from the object or force.

The materials of the present invention may be used in any application where impact resistance is desirable, with preferred applications being in the transportation arena, such as land vehicles, boats or aircraft, with automotive vehicles (e.g. cars, trucks, buses, etc.) being the most preferred area of application. Within an automotive vehicle it is possible to use the materials of the present invention as vehicle trim components, bumper facia, body panels, wheel wells, underbody panels, interior trim components, deck lids, seat components, handles, cargo liners, instrument panels, engine compartment components, or the like. Also possible hybrid articles might be made by combining the materials of the present invention with a different material in a layered combination. Other materials may include metals, plastics, ceramics, combinations thereof or the like. For example, an adhesive, such as an organoborane adhesive (see, e.g., “Amine Organoborane Complex Polymerization Initiators and Polymerizable Compositions”, PCT Publication No. WO 01/44311 A1, U.S. Ser. No. 09/466,321, herein incorporated by reference), may be used to bond together two layers of materials.

### EXAMPLES

Compositions according to the present invention were prepared by compounding the components using a twin screw extruder. The resultant compositions were pelletized and injection molded to form 5 inch square plaques that have a thickness of about ⅛ inch. One surface of the plaques was textured while another side was smooth. The amounts of each component are shown in Table 1. Polypropylene A1 is a homopolymer, while Polypropylene A2 is a heterophasic copolymer. Example A contains only a coupled ethylene-α-olefin (coupled ENGAGE® 8180), while Example B also contains a second ethylene-α-olefin elastomer (ENGAGE® 8180), which have Mooney viscosities of about 45 and about 35, respectively. Example C contains only the second ethylene-α-olefin elastomer. Example D contains a second ethylene-α-olefin elastomer and a hydrocarbon rubber with a Mooney viscosity of about 45 in the form of Nordel® 3745P. Comparative Example E contains only Nordel® 3745P, while Comparative Example F contains Nordel® 4770R, which is another hydrocarbon rubber with a Mooney viscosity of about 75.

TABLE 1
Compositions

| | | | | | Comparative | Comparative |
|---|---|---|---|---|---|---|
| | Example A | Example B | Example C | Example D | Example E | Example F |
| | (% by wt) | (% by wt) | (% by wt) | (% by wt) | (% by wt) | (% by wt) |
| Polypropylene A1 | 51.5 | 51.5 | 51.5 | 51.5 | 51.5 | 51.5 |
| Polypropylene A2 | 11.0 | 11.0 | 11.0 | 11.0 | 11.0 | 11.0 |
| Coupled | 15.0 | 7.5 | | | | |
| ENGAGE ® 8180 | | | | | | |
| ENGAGE ® 8180 | | 7.5 | 15.0 | 7.5 | | |
| Nordel 3745P | | | | 7.5 | 15.0 | |
| Nordel 4770R | | | | | | 15.0 |
| Antioxidant | 0.2 | 0.2 | 0.2 | 0.2 | 0.2 | 0.2 |
| Thermal Stabilizer | 0.3 | 0.3 | 0.3 | 0.3 | 0. | 0.3 |
| Talc | 22.0 | 22.0 | 22.0 | 22.0 | 22.0 | 22.0 |

Each of the Example compositions was subjected to gloss testing using Gardener gloss meter using the protocol as set forth in ASTM D-523. Textured and smooth surfaces of each composition were tested with a 60° angle of incidence and a 20° angle of incidence. The difference between the two measurements or delta provides an indication of the gloss of the composition, with a lower delta representing lower gloss.

TABLE 2
Gloss Measurement

| | Example A | Example B | Example C | Example D | Example E | Example F |
|---|---|---|---|---|---|---|
| Textured Surface, 60° | 5.78 | 5.24 | 5.10 | 4.88 | 4.90 | 4.66 |
| Textured Surface, 20° | 0.96 | 0.90 | 0.90 | 0.80 | 0.80 | 0.80 |
| Δ Gloss, Textured Surface | 4.82 | 4.34 | 4.20 | 4.08 | 4.10 | 3.86 |
| Smooth Surface, 60° | 21.74 | 17.20 | 18.50 | 13.02 | 13.66 | 10.14 |
| Smooth Surface, 20° | 3.62 | 2.72 | 2.92 | 1.94 | 2.16 | 1.50 |
| Δ Gloss, Smooth Surface | 18.12 | 14.48 | 15.58 | 11.08 | 11.50 | 8.64 |

Each of the example compositions was subjected to various physical properties testing including testing flex modulus (ASTM D-790), tensile strength at yield (ASTM D-638), elongation at yield (ASTM D-638), impact resistance (ASTM D-256: notched izod method) and distortion temperature under load (DTUL)(ASTM D-648), are listed in Table 3.

TABLE 3
Physical Properties±

| | | | | | Comparative | Comparative |
|---|---|---|---|---|---|---|
| | Example A | Example B | Example C | Example D | Example E | Example F |
| Flex Modulus | 1926 ± 61 | 1805 ± 52 | 2016 ± 71 | 2099 ± 45 | 1893 ± 103 | 1970 ± 51 |
| (1% sec, 5 mm/min), Mpa | | | | | | |
| Tensile Strength, Mpa | 24.0 ± 61 | 23.6 ± 0.3 | 23.7 ± 0.1 | 23.9 ± 0.1 | 23.5 ± 0.1 | 22.9+/0.1 |
| Elongation, Mpa | 5.4 ± 0.3 | 5.5 ± 0.9 | 5.4 ± 0.2 | 4.5 ± 0.2 | 5.7 ± 0.3 | 4.4 ± 0.2 |
| Notched Izod at 23° C., | 3.4 ± 0.3 | 3.4 ± 0.3 | 2.9 ± 0.4 | 2.0 ± 0.1 | 2.8 ± 0.1 | 1.6 ± 0.2 |
| ft-lbs/in | | | | | | |
| DTUL at 0.455 Mpa, ° C. | 108 | 106 | 109 | 114 | 105 | 107 |
| DTUL at 1.83 Mpa, ° C. | 60 | 58 | 62 | 63 | 57 | 59 |

As can be seen Examples A and B, both of which contain coupled elastomer have superior impact resistance as measured by the notched izod method, while having comparable textured surface gloss to the Comparative Examples E and F. Examples C and D show comparable impact resistance with comparable textured surface gloss to the Comparative examples. All the Examples show a cost effective material may be used in place of or partially in place of a more expensive material, while obtaining superior or comparable impact resistance, gloss, or both.

It will be further appreciated that functions or structures of a plurality of components or steps may be combined into a single component or step, or the functions or structures of one step or ingredient may be split among plural steps or ingredients. The present invention contemplates all of these combinations. Unless stated otherwise, amounts and ranges of the various ingredients depicted herein are not intended to be restrictive of the invention, and other amounts and ranges are possible. In addition, while a feature of the present invention may have been described in the context of only one of the illustrated embodiments, such feature may be combined with one or more other features of other embodiments, for any given application. It will also be appreciated from the above that the fabrication of the unique compositions herein and the use thereof also constitute methods in accordance with the present invention. Unless otherwise noted, the use of “a” or “an” is intended to foreclose other steps or ingredients. Nor does the use of terms such a “first” or “second” foreclose additional steps or ingredients, nor foreclose completing steps or adding ingredients in a different order.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. An impact resistant composition, comprising:
a polyolefin;
a first elastomer having a physical property; and
a second elastomer having a different magnitude of the physical property in the first elastomer,
wherein the composition exhibits a low gloss.

2. The composition of claim 1, wherein the physical property is Mooney viscosity.

3. The composition of claim 2, wherein the Mooney viscosity of the first elastomer is greater than about 40 and the Mooney viscosity of the second elastomer is less than about 40.

4. The composition of claim 3, wherein the first elastomer is a coupled elastomer.

5. The composition of claim 4, wherein the coupled elastomer is a metallocene catalyzed ethylene-α-olefin elastomer.

6. The composition of claim 5, wherein the second elastomer is a metallocene catalyzed ethylene-α-olefin elastomer.

7. The composition of claim 6, wherein the coupled elastomer is the coupled version of the second elastomer.

8. The composition of claim 1, wherein the polyolefin is blend of at least two polypropylenes.

9. The composition of claim 1, further comprising one or more of an inorganic filler, a thermal stabilizer, ignition resistant filler, a flame retardant, an antibacterial agent, an anti-mildew agent, an ultraviolet absorber, an antioxidant, a plasticizer, a coloring agent, an antistatic agent, and combinations thereof.

10. The composition of claim 1, wherein the polypropylene blend is present in about 50 wt % to about 90 wt %, the coupled elastomer is present in about 5 wt % to about 20 wt % by weight, second elastomer is present in about 5 wt % to about 20 wt % by weight, and the balance is one or more fillers.

11. The composition of claim 10, wherein the polypropylene blend is present in about 60 wt % to about 70 wt %, the coupled elastomer is present in about 5 wt % to about 20 wt % by weight, the second elastomer is present in about 12.5 wt % to about 17.5 wt % by weight, and the balance is one or more fillers.

12. The composition of claim 1, wherein low gloss is a delta gloss of a textured surface of less than about 5.00 as measure by ASTM D-523.

13. The composition of claim 1, wherein low gloss is a delta gloss of a smooth surface of less than about 16.00 as measure by ASTM D-523.

14. An impact resistant composition, consisting:
a polyolefin;
a coupled elastomer with a Mooney viscosity of greater than about 40.

15. The composition of claim 14, further consists a second elastomer with a Mooney viscosity of less than about 40.

16. The composition of claim 15, wherein the coupled elastomer is a metallocene catalyzed ethylene-α-olefin elastomer.

17. The composition of claim 16, wherein the second elastomer is a metallocene catalyzed ethylene-α-olefin elastomer.

18. The composition of claim 17, wherein the coupled elastomer is the coupled version of the second elastomer.

19. The composition of claim 14, wherein the polyolefin is blend of at least two polypropylenes.

20. The composition of claim 14, further consisting one or more of an inorganic filler, a thermal stabilizer, ignition resistant filler, a flame retardant, an antibacterial agent, an anti-mildew agent, an ultraviolet absorber, an antioxidant, a plasticizer, a coloring agent, an antistatic agent, and combinations thereof.

21. The composition of claim 14, wherein the polypropylene blend is present in about 50 wt % to about 90 wt %, the coupled elastomer is present in about 5 wt % to about 20 wt % by weight, second elastomer is present in about 5 wt % to about 20 wt % by weight, and the balance is one or more fillers.

22. The composition of claim 21, wherein the polypropylene blend is present in about 60 wt % to about 70 wt %, the coupled elastomer is present in about 5 wt % to about 20 wt % by weight, the second elastomer is present in about 12.5 wt % to about 17.5 wt % by weight, and the balance is one or more fillers.

23. A composition, comprising:
a polypropylene blend with a heat of crystallization of greater than about 150° C.;
a coupled ethylene-α-olefin with a Mooney viscosity of greater than about 40;
an ethylene-α-olefin with a Mooney viscosity of between about 30 and about 40.

24. The composition of claim 22, wherein the polypropylene blend is present in about 60 wt % to about 70 wt %, the coupled ethylene-α-olefin is present in about 5 wt % to about 20 wt % by weight, the ethylene-α-olefin is present in about 12.5 wt % to about 17.5 wt % by weight, and the balance is one or more fillers.
